(19) United States
(12) Patent Application Publication
(10) Pub. No.: US 2014/0193157 A1
(43) Pub. Date: Jul. 10, 2014

(54) Device and Method for Controlling Electronic Appliance

(71) Applicant: O2Micro Inc., Santa Clara, CA (US)

(72) Inventors: Sterling Du, Shanghai (CN); Jing Chen, Wuhan (CN); Weitai Yang, Shanghai (CN); Qiang Guan, Shanghai (CN); Yang Wang, Wuhan (CN); Yating Li, Wuhan (CN)

(21) Appl. No.: 13/908,247

(22) Filed: Jun. 3, 2013

(30) Foreign Application Priority Data
Jan. 7, 2013 (CN) 201310005013.3

(51) Int. Cl. G08C 23/04

(52) U.S. Cl. CPC G08C 23/04
USPC 398/106

(57) ABSTRACT

A mobile terminal device for controlling an electronic appliance. The mobile terminal device includes a picture acquisition unit, an information identification unit, a control file acquisition unit and an infrared control unit. The picture acquisition unit is configured to acquire pictures of the electronic appliance. The information identification unit is configured to process the pictures and perform character recognition on the pictures to identify device information of the electronic appliance. The control file acquisition unit is configured to acquire a control file from a database of control files according to the device information identified by the information identification unit. The infrared control unit is configured to control an infrared emission unit to emit an infrared control signal according to the control file acquired by the control file acquisition unit.

### RELATED APPLICATIONS

This application claims priority to Chinese Patent Application No. 201310005013.3, filed on Jan. 7, 2013 with the State Intellectual Property Office of the People's Republic of China, the specification of which is incorporated by reference in its entirely herein.

### FIELD OF THE PRESENT TEACHING

The present invention relates generally to a field of controlling of an electronic appliance, specifically to controlling of an electronic appliance by a mobile terminal device.

### BACKGROUND

With the development of mobile terminal devices, such as mobile phones, people tend to rely on the mobile phones to perform more functions such as using the mobile phones as universal remote controllers for controlling electronic appliances. A conventional universal remote controller can be programmed to operate various brands of electronic appliances. A manufacturer programs multiple control files in the universal remote controller to control different electronic appliances. A control file includes infrared codes which can control a corresponding electronic appliance. For example, a control file A can instruct the universal remote controller to emit infrared signals to adjust volumes of television A, while a control file B can instruction the universal remote controller to emit infrared signals to adjust volumes of television B. Codes in the control file A and codes in the control file B are different. Most of the conventional universal remote controllers use tree traversal method which involves visiting each node in a tree data structure composed by all the control files to locate the correct control file for a certain electronic appliance. It may need to browse all the control files in the universal remote controller in a certain sequence until the correct control file has been found. The more electronic appliances the controller can control, the longer time a user has to wait for the electronic appliance to respond. If a user wants to locate the correct control file in a short time, the user has to type in device information of the electronic appliance such as brand information or model information manually. For elderly people, they often do not know which kind of information belongs to the device information and where to find such information. Even though the elderly people manage to find the device information of the electronic appliance, it is still difficult for them to type the device information into the mobile terminal device. Moreover, if device information typed in is not correct, the mobile terminal device will be unable to acquire the correct control file to control the electronic appliance.

Therefore, there is a need for a better universal remote controller to locate a correct control file for an electronic appliance in a more intelligent way and it is this need that the present invention is primarily directed to.

### SUMMARY

The embodiments described herein relate to methods and device for controlling electronic appliances.

In an embodiment, a mobile terminal device for controlling an electronic appliance is disclosed. The mobile terminal device includes a picture acquisition unit, an information identification unit, a control file acquisition unit and an infrared control unit. The picture acquisition unit is configured to acquire pictures of the electronic appliance. The information identification unit is configured to execute image process on the pictures and perform character recognition on the pictures to identify device information of the electronic appliance. The control file acquisition unit is configured to acquire a control file from a database of control files according to the device information identified by the information identification unit. The infrared control unit is configured to control an infrared emission unit to emit an infrared control signal according to the control file acquired by the control file acquisition unit.

In another embodiment, a method for controlling an electronic appliance is disclosed. The method includes acquiring pictures of the electronic appliance by a picture acquisition unit of the mobile terminal device; identifying device information of the electronic appliance by processing the pictures and performing character recognition on the pictures by an information identification unit of the mobile terminal device; accessing a database of control files to acquire a control file by a control file acquisition unit of the mobile terminal device according to the device information; and controlling an infrared emission unit of the mobile terminal device to emit an infrared control signal according to the control file to control the electronic appliance.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description below.

### BRIEF DESCRIPTION OF THE DRAWINGS

Features and advantages of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of a mobile terminal device for controlling an electronic appliance, in accordance with an embodiment of the present invention; and

FIG. 2 illustrates a flowchart of a method for controlling an electronic appliance by a mobile terminal device, in accordance with an embodiment of the present invention.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

The present invention enables a mobile terminal device such as a mobile phone to act as a universal remote controller to control electronic appliances.

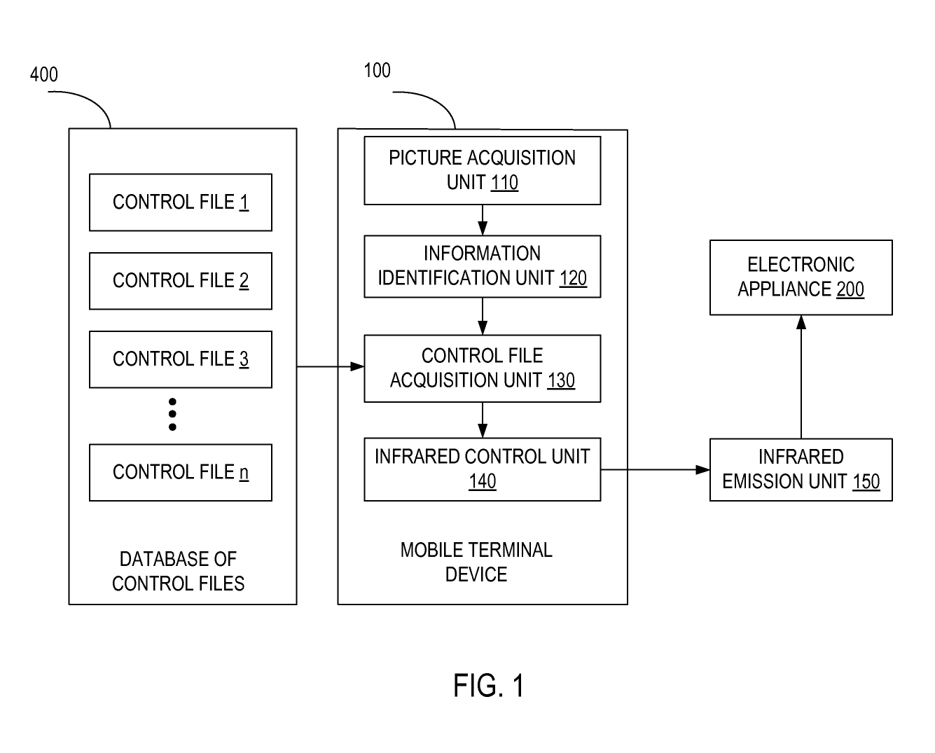

FIG. 1 illustrates a block diagram of a mobile terminal device 100 for controlling an electronic appliance 200, in accordance with an embodiment of the present invention. As shown in FIG. 1, the mobile terminal device 100 includes a picture acquisition unit 110, an information identification unit 120, a control file acquisition unit 130 and an infrared control unit 140.

The picture acquisition unit 110 is configured to acquire pictures for the electronic appliance 200. The information identification unit 120 is configured to identify device information of the electronic appliance 200 by processing the pictures and performing character recognition on the processed pictures acquired by the picture acquisition unit 110. The control file acquisition unit 130 is configured to acquire one or more control files from a database of control files 400 according to the device information of the electronic appliance 200. The infrared control unit 140 is configured to control an infrared emission unit 150 to emit an infrared control signal according to the one or more control files acquired by the control file acquisition unit 130. The infrared control signal is used for controlling the electronic appliance 200. As shown in FIG. 1, the infrared emission unit 150 is located outside of the mobile terminal device 100 and is coupled to the mobile terminal device 100 externally. Alternatively, the infrared emission unit 150 can be integrated into the mobile terminal device 100 as a built-in component of the mobile terminal device 100.

The mobile terminal device 100 may be, but not limit to, a mobile phone, a personal digital assistant (PDA), a tablet PC or other mobile terminals. More specifically, taking a mobile phone as an example, the infrared emission unit 150 can be coupled to an audio connector (e.g., a headphone connector) or a data connector (e.g., a docket connector) of the mobile phone to emit the infrared control signal. The infrared emission unit 150 is configured to emit the infrared control signal to control the electronic appliance 200. The infrared control signal may contain an infrared code retrieved from the control file acquired by the control file acquisition unit 130. The electronic appliance 200 includes, but not limit to, a television, an air conditioner or other household appliances. The following description will use the mobile phone as an example of the mobile terminal device 100 to illustrate the operation of the mobile terminal device 100.

The picture acquisition unit 110 acquires pictures of the electronic appliance 200. The pictures can be pictures of the electronic appliance 200 itself or pictures of a remote control device for the electronic appliance 200. The pictures should contain an image showing the brand and/or model of the electronic appliance 200 which is located on the electronic appliance 200 or located on a remote control device of the electronic appliance 200.

As an example, the picture acquisition unit 110 may be a picture capturing unit integrated in the mobile terminal device 100, e.g., a camera of the mobile phone. If the electronic appliance 200 is a television, considering that most televisions can include a trademark of a logo located at the lower part of the front side of the televisions which indicates device information such as brand and/or model of the television, a user can take pictures of the lower part of the front side of the television first. Some televisions include a barcode at the back side of the televisions which may also indicate device information such as brand and/or model of the television, the user can also take pictures of the back side of the televisions. In addition, the remote control devices of some televisions may also show the device information about the televisions. The user can further take pictures of both front side and back side of the remote control devices.

The above picture capturing process may be finished in one time to take all the pictures of both front and back side of the television and both front and back side of the remote control device. Alternatively, the above picture capturing process may also be divided into several steps in a certain sequence. For example, the user may capture a picture showing the front side of the television first to check whether this picture has carried enough device information of the television and then to decide whether to capture more pictures such as back side pictures of the television. More specifically, the user takes a picture of the front side of the television first. The picture acquisition unit 110 transmits the picture to the information identification unit 120. If the information identification unit 120 can identify device information of the television, no more pictures need to be taken. Otherwise, if the information identification unit 120 cannot identify device information of the television, the mobile terminal device 100 determines that the picture of the front side of the television has not carried enough information of the television. In such case, a picture of the back side of the television or even pictures of remote controller of the television need to be taken. The mobile terminal device 100 can indicate to the user that another picture needs to be taken. More specifically, the information identification unit 120 displays a message on a screen of the mobile terminal device 100 to inform the user to take another picture of the television from another angle. Alternatively, an audio message used to indicate to the user the need for taking another picture may be produced by the mobile terminal device 100.

Alternatively, the picture acquisition unit 110 may act as a storage unit for the mobile terminal device and may also receive data from an external device. In such case, the picture acquisition unit 110 is configured to receive pictures of the electronic appliance 200 from an external device. If the mobile terminal device 100, such as the mobile phone, is not equipped with a picture capturing unit or the picture capturing unit of the mobile terminal device 100 is out of order temporarily, the user can take pictures of the electronic appliance 200 or its remote control device using another device such as a digital camera and the pictures are then transmitted from the digital camera to the picture acquisition unit 110.

After obtaining one or more pictures, the picture acquisition unit 110 transmits the pictures to the information identification unit 120. The information identification unit 120 identifies device information of the electronic appliance 200 by processing the pictures received and performing character recognition on the processed pictures. For example, the information identification unit 120 performs image processing on the pictures, such as sharpening, noise reduction, and gray scale processing. The information identification unit 120 may be implemented by an OCR (optical character recognition) software on the market which has a function of image processing and/or character identification. The information identification unit 120 performs an OCR process on the pictures. The device information of the electronic appliance 200 may be derived from the result of the OCR process.

Optionally, the mobile terminal device 100 may determine whether the identification of device information is successful by searching a list of device information which is pre-stored in the mobile terminal device 100. For example, if the device information identified by the information identification unit 120 can be found in the list, the identification is considered to be successful. Otherwise, if the device information identified by the information identification unit 120 is not in the list, the identification is considered as a failure.

If the mobile terminal device 100 determines that the identification has failed, the mobile terminal device 100 informs the user to take another picture of the electronic appliance 200 or its remote control device. The above procedure may be repeated until the information identification unit 120 identifies the device information of the electronic appliance 200 successfully. Alternatively, after each failure, the mobile terminal device 100 can request the user to type in the device information manually. In addition, after each failure, the mobile terminal device 100 may provide an option to let the user to enter the device information or take another picture. After acquiring device information of the electronic appliance, either by identifying the one or more pictures of the electronic appliance 200 or by receiving the device information manually inputted by the user, the information identification unit 120 transmits the acquired device information to the control file acquisition unit 130. The acquired device information includes acquired brand information and acquired model information of the electronic appliance 200.

Alternatively, the operation of determining whether the identification of the device information is successful can be skipped. In a default setting, the mobile terminal device 100 takes the device information identified by the information identification unit 120 as the actual device information of the electronic appliance 200, without searching the list of device information to determine whether the same device information is contained in the list. In such case, after identifying the device information of the electronic appliance 200, the information identification unit 120 transmits the device information to the control file acquisition unit 130 directly.

The control file acquisition unit 130 accesses the database of control files 400 to acquire one or more control files according to the device information of the electronic appliance 200. There are multiple control files such as control file 1, control file 2 . . . and control file n stored in the database of control files 400. Each control file includes infrared code for controlling remotely a corresponding electronic appliance. As an example, if the electronic appliance 200 is a television, a corresponding control file includes infrared codes for powering on/off the television, switching channels and adjusting volume.

More specifically, the control file acquisition unit 130 performs an accurate matching to search for an accurately matched control file in the database of control files 400 according to the device information for the particular device received from the information identification unit 120. The accurately matched control file is a control file that accurately matches both the brand information and the model information of the electronic appliance 200. In other words, the accurately matched control file contains the control information for the exact brand information and exact model information of the electronic appliance 200.

If there is no accurately matched control file found in the database of control files 400, the control file acquisition unit 130 then executes a fuzzy matching to acquire one or more fuzzily matched control files from the database of control files 400. A fuzzy matching process is a process that takes into account of both the brand information and model information, assigns weights for brand information and model information to identify a control file as a fuzzily matched control file or a non-matched control file, and generates a score of similarity to each control file to show the probability that the control file may refer to the electronic appliance 200. The scores of similarity are determined by considering weights and both brand information and model information and are determined by the control file acquisition unit 130. For example, assume that the similarity between the brand information in a control file and the acquired brand information of the electronic appliance 200 is 80 percent. Assume that the similarity between the model information in the control file and the acquired model information of the electronic appliance 200 is 70 percent. The acquired brand information and the acquired model information of the electronic appliance 200 are acquired by the information identification unit 120 by either identifying one or more pictures of the electronic appliance 200 or receiving the device information manually inputted by the user. If the weight for the brand information is 50 percent and the weight for the model information is also 50 percent, the score of similarity of this control file is calculated by 50%*80%+50%*70%. Control files with scores of similarity above a threshold and below 100 percent are identified as fuzzily matched controls, while control files with scores of similarity below the threshold are identified as non-matched control files. For example, a fuzzily matched control file may have similar brand information or similar model information with the device information of the electronic 200. Alternately, a fuzzily matched control file may be a control file that contains control information for the exact brand information but similar model information with the device information of the electronic appliance 200, or may be a control file that contains control information for similar brand information but the exact model information with the device information of the electronic appliance 200.

If there is a mismatch between the device information acquired by the mobile terminal device 100 and the actual device information of the electronic appliance 200, the fuzzy matching is useful for acquiring the corresponding control file of the electronic appliance 200. The database of control files 400 may not include a corresponding control file for a particular electronic appliance, but include a control file for an electronic appliance of a similar brand information or similar model information and such control file may be used for controlling this particular electronic appliance. In such case, the fuzzy matching is also useful.

If no control file is found after running both the accurate matching and the fuzzy matching, the control file acquisition unit 130 acquires a predetermined number of control files from the database of control files 400 randomly. For example, the mobile terminal device 100 acquires five to ten control files from the database 400 randomly.

After acquiring control files through any of the above methods, the control file acquisition unit 130 transmits one or more acquired control files to the infrared control unit 140. The infrared control unit 140 controls the infrared emission unit 150, which is coupled to the mobile terminal device and emits an infrared control signal according to the one or more acquired control files.

If the control file acquired by the control file acquisition unit 130 is an accurately matched control file or is the only one fuzzily matched control file in the database of control files 400, the infrared control unit 140 controls the electronic appliance 200 according to the control file directly. If there are more than one fuzzily matched control files in the database of control files 400, the control file acquisition unit 130 chooses a control file having the highest score of similarity and transmits it to the infrared control unit 140 to control the electronic appliance 200. Alternatively, the control file acquisition unit 130 can transmit all the fuzzily matched control files to the infrared control unit 140. Then the infrared control unit 140 instructs the infrared emission unit 150 to emit the infrared control signal according to each of the control files successively. If there is no accurately matched control files or fuzzily matched control files found in the database of control files 400, the control file acquisition unit 130 acquires a predetermined number of control files randomly from the database of control files 400 and transmits them to the infrared control unit 140. Similarly, the infrared control unit 140 instructs the infrared emission unit 150 to emit the infrared control signal according to each of the control file successively.

After the mobile terminal device 100 instructs the infrared emission unit 150 to emit the infrared control signal and the electronic appliance follows the infrared control signal correctly, this means that the mobile terminal device has acquired the correct corresponding control file of the electronic appliance 200 from the database of control files 400 and the mobile terminal device 100 can be used from then on as a remote controller for the electronic appliance 200. For example, if the electronic appliance 200 is a television, in a default setting, the mobile terminal device 100 instructs the infrared emission unit 150 to emit the infrared control signal which is capable to powering on/off the television. The television performs function according to the infrared control signal if the television is turned on or turned off after the infrared control signal is emitted. Then the mobile terminal device 100 can be used as a remote controller for the electronic appliance 200. The mobile terminal device 100 offers users multiple choices of different instructions to control the electronic appliance 200.

On the other hand, if after the mobile terminal device 100 instructs the infrared emission unit 150 to emit the infrared control signal and the electronic appliance 200 does not perform functions according to the infrared control signal, this means that the mobile terminal device 100 has not acquired the correct corresponding control file for the electronic appliance 200. The failure may be caused by an error of the device information identified by the information identification unit 120, or may be caused by lack of a corresponding control file for the electronic appliance 200 in the database of control files 400. Then the user can restart the process, including acquiring pictures of the electronic appliance 200 by the picture acquisition unit 110, identifying device information of the electronic appliance 200 by the information identification unit 120, acquiring the corresponding control file of the electronic appliance 200 by the control file acquisition unit 130, and emitting the infrared control signal to control the electronic appliance 200 by the infrared emission unit 150.

As shown in FIG. 1, the database of control files 400 can be stored in an external server. The mobile terminal device 100 downloads the control files from the external server through a wired network or a wireless network such as a 3G network and a Wi-Fi network. Alternatively, the database of control files can also be pre-stored in the mobile terminal device 100. The mobile terminal device 100 extracts the control file directly from the pre-stored database 400.

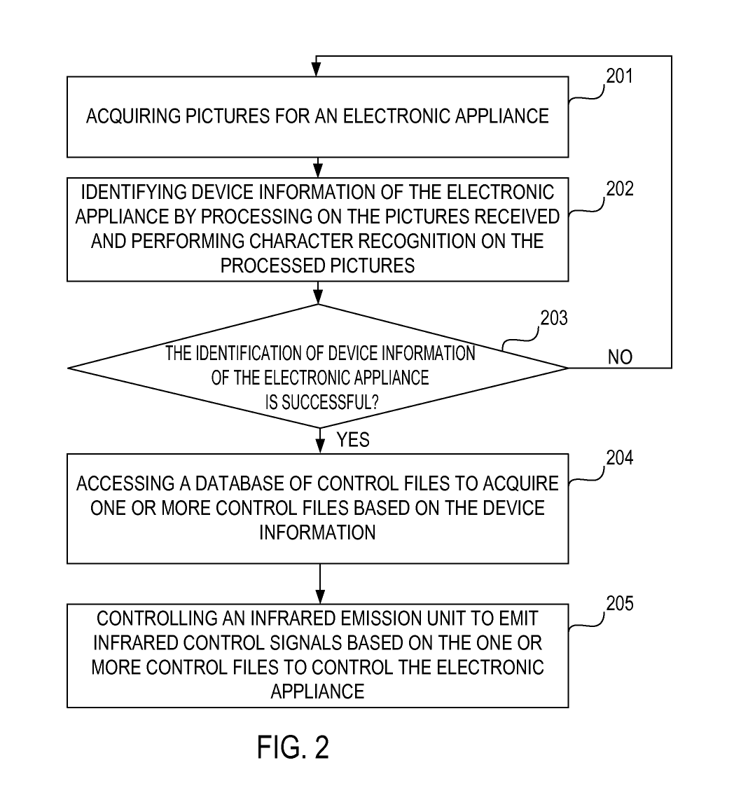

FIG. 2 illustrates a flowchart of a method for controlling an electronic appliance 200 by a mobile terminal device 100, in accordance with an embodiment of the present invention. FIG. 2 is described in combination with FIG. 1.

The mobile terminal device 100 includes, but not limit to, a mobile phone, a personal digital assistant (PDA), a tablet PC or other mobile terminals. The electronic appliance 200 includes, but not limit to, a television, an air conditioner or other household appliances.

At the beginning, one or more pictures for the electronic appliance 200 are acquired, e.g., by a picture acquisition unit 110 in the mobile terminal device 110, and are transmitted to an information identification unit 120, step 201. The pictures can be pictures of the electronic appliance 200 itself or pictures of a remote control device for the electronic appliance 200. The pictures should contain an image showing the brand and/or model of the electronic appliance 200. As an example, the picture acquisition unit 110 may be a picture capturing unit integrated in the mobile terminal device 100, e.g., a camera of the mobile phone. As another example, the picture acquisition unit 110 may be a storage unit in the mobile terminal device 110 and can receive data from an external device.

More specifically, if the picture acquisition unit 110 is a camera, a user takes pictures of the electronic appliance 220 by using the camera. If the electronic appliance 200 is a television, considering that most televisions include a brand name or a logo located at the lower part of the front side of the television that indicates device information, such as brand and/or model of the television, the picture acquisition unit 110 may request the user to take several pictures for the television in a sequence from the front side of the television, to the back side of the television, then to the front side of the remote controller and to the back side of the remote controller. Alternatively, the picture acquisition unit 110 may only require the user to take a picture of the front side of the television and transmit the picture to the information identification unit 120.

Alternatively, if the mobile terminal device 100 such as the mobile phone is not equipped with a picture capturing unit or the picture capturing unit is out of order temporarily, the picture acquisition unit 110 may be a storage unit and receive pictures of the electronic appliance 200 from an external device. The user takes pictures of the electronic appliance 200 or its remote control device using another device such as a digital camera and then transmits the pictures to the picture acquisition unit 110. In this way, pictures of the electronic appliances 200 are also acquired by the picture acquisition unit 110.

After the step 201, the process goes to step 202 where device information of the electronic appliance 200 is identified by processing the pictures and performing character recognition on the processed pictures. The step 202 can be performed by, for example, the information identification unit 120 in the mobile terminal device 100.

More specifically, after acquiring one or more pictures for the electronic appliance 200, image processing such as sharpening, noise reduction and gray scale processing may be performed on the pictures by the information identification unit 120. As an example, the information identification unit 120 may be implemented by an OCR software on the market which has a function of image processing and/or character identification. An OCR process on the picture is performed by the information identification unit 120. The device information of the electronic appliance 200 may be derived from the result of the OCR process.

The mobile terminal device 100 searches in a list of device information pre-stored in the mobile terminal device 100 to determine whether the identification of the device information of the electronic appliance 200 is successful is determined by searching in a list of device information pre-stored in the mobile terminal device 100, step 203. The step 203 is optional.

More specifically, if the device information identified by the information identification unit 120 can be found in the list, the identification is considered to be successful. If the device information identified by the information identification unit 120 is not in the list, the identification is considered to have failed.

If the identification is considered to have failed, the process goes back to the step 201. The user is informed, e.g., by the mobile terminal device 100, to take another picture of the electronic appliance 200 or its remote control device. The above process can be repeated until the device information of the electronic appliance 200 is identified successfully. Alternatively, after each failure, the user can be offered with an option, e.g., by the mobile terminal device 100, either to type in the device information manually or to try to take another picture. After acquiring device information of the electronic appliance 200, the process goes to step 204.

Alternatively, the operation of determining whether the identification of the device information is successful can be skipped. In a default setting, the device information identified by the information identification unit 120 is considered as the actual device information of the electronic appliance 200. The process can go from the step 201 to the step 204 directly, skipping the step 203.

After the identification of the device information of the electronic appliance 200, one or more control files according to the device information can be acquired through accurate matching and/or fuzzy matching, e.g., by a control file acquisition unit 130 in the mobile terminal 100, step 204.

More specifically, the accurate matching is performed, e.g., by the control file acquisition unit 130, to search for an accurately matched control file in the database of control files 400 that accurately matches both the brand information and the model information of the electronic appliance 200 according to the device information. If there is no accurately matched control file found in the database of control files 400, a fuzzy matching can be executed, e.g., by the control file acquisition unit 130, to acquire one or more fuzzily matched control files from the database of control files 400. A fuzzily matched control file may have similar brand information or similar model information with the device information of the electronic appliance 200. Alternately, a fuzzily matched control file may be a control file which contains control information for the exact brand information but similar model information with the device information of the electronic appliance 200, or may be a control file which contains control information for similar brand information but the exact model information with the device information of the electronic appliance 200.

If no control file is found after running both of the accurate matching and the fuzzy matching, a predetermined number of control files can be obtained, e.g., by the control file acquisition unit 130, from the database of control files 400 randomly. For example, the mobile terminal device 100 acquires five to ten control files from the database 400 randomly.

After acquiring control files through any above methods, infrared control signals are emitted to control the electronic appliance 200 according to the one or more acquired control files, step 205. The step 205 can be performed by an infrared emission unit 150. For example, the infrared emission unit 150 can be coupled to an audio connector (e.g., a headphone connector) or a data connector (e.g., a docket connector) of the electronic appliance 200. Alternatively, the infrared emission unit 150 can also be integrated in the mobile terminal device 100 as a built-in component of the mobile terminal device 100.

More specifically, if the control file acquired by the control file acquisition unit 130 is an accurately matched control file or is the only one fuzzily matched control file in the database of control files 400, the infrared control unit 140 controls the electronic appliance 200 according to the control file directly. If there are more than one fuzzily matched control files in the database of control files 400, the control file acquisition unit 130 chooses a control file having the highest score of similarity and transmits it to the infrared control unit 140 to control the electronic appliance 200. Alternatively, the control file acquisition unit 130 can transmit all the fuzzily matched control files to the infrared control unit 140. Then the infrared control unit 140 instructs the infrared emission unit 150 to emit the infrared control signal according to each control file successively. If there is no accurately matched control files or fuzzily matched control files found in the database of control files 400, the control file acquisition unit 130 acquires a predetermined number of control files randomly from the database of control files 400 and transmits them to the infrared control unit 140. Similarly, the infrared control unit 140 instructs the infrared emission unit 150 to emit the infrared control signal according to each of the control file successively.

After instructing the infrared emission unit 150 to emit the infrared control signal and the electronic appliance 200 correctly responds to the infrared control signal, it means that the mobile terminal device 100 has acquired the correct corresponding control file of the electronic appliance 200 from the database of control files and the mobile terminal device 100 can be used from then on as a remote controller for the electronic appliance 200.

On the other hand, after instructing the infrared emission unit 150 to emit the infrared control signal but the electronic appliance 200 does not perform the correct function according to the infrared control signal, it means that the mobile terminal device 100 has not acquired the correct corresponding control file for the electronic appliance 200. The failure may be caused by an error of the device information identified by the information identification unit 120, or may be caused by lack of a corresponding control file for the electronic appliance 200 in the database of control files 400. The user then can go over the process from the step 201 to the step 205.

The database of control files 400 can be stored in an external server. The mobile terminal device 100 downloads the control files from the external server though a wired network or a wireless network such as a 3G network, a Wi-Fi network. Alternatively, the database of control files 400 can be pre-established in the mobile terminal device 100 and the mobile terminal device 100 extracts the control files directly from the pre-established database.

Accordingly, the present invention provides a mobile terminal device for controlling electronic appliances. The mobile terminal device can recognize device information of the electronic appliance automatically without a need for a manual input process by users. It is useful for some people who have difficulties to find out or type in the correct device information of the electronic appliance, such as elder people. Moreover, the mobile terminal device disclosed in the present invention can be used as a remote controller of an electronic appliance without a need to perform a traversal process to find a correct control file which is needed by conventional universal remote controllers.

Those skilled in the art will recognize that the embodiments of the present teaching are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A mobile terminal device for controlling an electronic appliance, the mobile terminal device comprising:
a picture acquisition unit for acquiring pictures of the electronic appliance;
an information identification unit for processing the pictures and performing character recognition on the pictures to identify device information of the electronic appliance;
a control file acquisition unit for acquiring a control file from a database of control files according to the device information identified by the information identification unit; and
an infrared control unit for controlling an infrared emission unit to emit an infrared control signal according to the control file acquired by the control file acquisition unit.

2. The mobile terminal device of claim 1, wherein the infrared emission unit is an external device and coupled to the mobile terminal device.

3. The mobile terminal device of claim 1, wherein the infrared emission unit is integrated into the mobile terminal device.

4. The mobile terminal device of claim 1, wherein the control file acquisition unit acquires the control file by performing an accurate matching, wherein the control file acquired by the control file is an accurately matched control file that contains control information for the exact brand and exact model of the electronic appliance.

5. The mobile terminal device of claim 1, wherein the control file acquisition unit acquires the control file by performing a fuzzy matching, wherein the control file acquired by the control file is a fuzzily matched control file that contains similar brand and similar model of the electronic appliance.

6. The mobile terminal device of claim 1, wherein the control file acquisition unit acquires a predetermined number of control files randomly from the database of control files if the database of control files does not include a control file that matches the device information.

7. The mobile terminal device of claim 1, wherein control file acquisition unit downloads the control file through a network from an external server in which the database of control files is stored.

8. The mobile terminal device of claim 1, wherein the database of control files is stored in the mobile terminal device, and wherein the control file acquisition unit extracts the control file from the stored database of control files.

9. The mobile terminal device of claim 1, wherein the device information comprises brand information and model information of the electronic appliance.

10. The mobile terminal device of claim 1, wherein the pictures for the electronic appliance comprise pictures of the electronic appliance and pictures of a remote control device for the electronic appliance.

11. The mobile terminal device of claim 1, wherein the picture acquisition unit is a picture capturing unit of the mobile terminal device capable of capturing pictures.

12. The mobile terminal device of claim 1, wherein the picture acquisition unit acts as a storage unit in the mobile terminal device and receives the pictures for the electronic appliance from an external device.

13. A method for controlling an electronic appliance by a mobile terminal device, comprising the steps of:
acquiring pictures of the electronic appliance by a picture acquisition unit of the mobile terminal device;
identifying device information of the electronic appliance by processing the pictures and performing character recognition on the pictures by an information identification unit of the mobile terminal device;
accessing a database of control files to acquire a control file by a control file acquisition unit of the mobile terminal device according to the device information; and
controlling an infrared emission unit by the mobile terminal device to emit an infrared control signal according to the control file to control the electronic appliance.

14. The method of claim 13, further comprising the step of:
searching in a list of device information pre-stored in the mobile terminal device to determine whether the identification of the device information of the electronic appliance is successful.

15. The method of claim 13, wherein the step of accessing a database of control files to acquire a control file further comprises the step of:
performing an accurate matching by the control file acquisition unit to obtain an accurately matched control file that contains control information for exact brand information and exact model information of the electronic appliance.

16. The method of claim 13, wherein the step of accessing a database of control files to acquire a control file further comprises the step of:
performing a fuzzy matching by the control file acquisition unit to obtain a fuzzily matched control file that contains control information for similar brand information and similar model information of the electronic appliance.

17. The method of claim 13, wherein the step of accessing a database of control files to acquire a control file further comprises the step of:
acquiring a predetermined number of control files randomly from the database of control files by the control file acquisition unit if the database of control files does not include a control file that matches the device information.

18. The method of claim 13, wherein the database of control files is stored in an external server which is coupled to the mobile terminal device through a network.

19. The method of claim 13, wherein the database of control files is stored in the mobile terminal device.

20. The method of claim 13, wherein the device information comprises brand information and model information of the electronic appliance.
